(19) United States
(12) Patent Application Publication
(10) Pub. No.: US 2009/0177520 A1
(43) Pub. Date: Jul. 9, 2009

(54) TECHNIQUES FOR CASUAL DEMAND FORECASTING

(76) Inventors: Arash Bateni, Toronto (CA); Edward Kim, Toronto (CA); Jean-Philippe Vorsanger, Toronto (CA); Rong Zong, Scarborough (CA)

Correspondence Address: JAMES M. STOVER;TERADATA CORPORATION, 2835 MIAMI VILLAGE DRIVE, MIAMISBURG, OH, 45342, US

(21) Appl. No.: 11/967,645

(22) Filed: Dec. 31, 2007

(51) Int. Cl. G06F 17/30

(52) U.S. Cl. 705/10

(57) ABSTRACT

Techniques for casual demand forecasting are provided. Information is extracted from a database and is preprocessed to produce adjusted input regression variables. The adjusted input regression variables are fed to a regression service to produce regression coefficients. The regression coefficients are then post processed to produce uplifts and adjustments to the uplifts for the regression coefficients.

### BACKGROUND

Enterprises are increasingly capturing, storing, and mining a plethora of information related to communications with their customers. Often this information is stored and indexed within databases. Once the information is indexed, queries are developed on an as-needed basis to mine the information from the database for a variety of organizational goals: such as planning, analytics, reporting, etc.

One activity that enterprises may greatly desire is the ability to project demand for products and services of their products. This is often referred to demand forecasting. The information housed in the enterprise database is mined to derive demand forecasting models.

Accurate demand forecast is crucial to various business activities, particularly inventory control and replenishment, and significantly contributes to the productivity and profit of organizations. At the present, suites of products model the historical sales data to forecast the future demand of products. The current approaches consist of seasonal adjustment of the sales patterns and extrapolation of demand using exponential moving averages. This approach, called projection, generally neglects the causes of the historical sales patterns and relies on the assumption that the future is a continuation of the past, and thus the conventional projection technique has limited accuracy.

Therefore, it can be seen that improved techniques for demand forecasting are needed.

### SUMMARY

In various embodiments, techniques for casual demand forecasting are provided. According to an embodiment, a method for casual demand forecasting is described. Information is extracted from a database using an SQL query. Regression processing is performed on the extracted information and post processing is performed against regression results to adjust the results for purposes of producing a demand forecasting model for an enterprise.

### BRIEF DESCRIPTION OF THE DRAWINGS

FIG. 1 is a diagram of a method for casual demand forecasting, according to an example embodiment.

FIG. 2 is a diagram of another method for casual demand forecasting, according to an example embodiment.

FIG. 3 is a diagram for yet another method for casual demand forecasting, according to an example embodiment.

### DETAILED DESCRIPTION

### Overview of Aggregation Models

Data scarcity is the main reason for aggregating the data.

For example, if there are insufficient number of promotional weeks in the product history, regression may produce unreliable coefficients for calculating uplifts for promotions.

Hence, there needs to be a rule that defines when a PDL has insufficient data and needs to be aggregated to a higher level.

Empirical Research has shown that when a product has an ARS greater than 3 and the number of promo weeks in history exceed 7 then aggregation is not needed.

In this case the multivariable regression is run at PDL level (HH model).

Aggregate models (based on aggregated data) are used in the remainder of the descriptions that follows. Some initial definitions follow as well.

Slow movers: A set of products that multivariable regression is unable to handle well. In this context, they are defined as any product with ARS less than 3.0 (this boundary can be further tuned or overridden by a parameter). An additive regression model (called ADD) may be preferred for these products.

Low promo frequency: The remaining products have ARS greater than 3.0 and promo weeks less than 7 (this boundary can be further tuned or overridden by a parameter). A multiplicative regression model (called MULT) is used for these products.

It is noted that currently, the default condition is not to use an ADD model. This is done by setting the ARS boundary to ARS=0.0. As a result HH and MULT models currently analyze all the products including slow movers (this is due to better Price Elasticity modeling in the MULT model). The ADD model however may be needed for some data sets, in such cases it is activated by setting the ARS boundary=3.

ARS (boundary = 3)

| | | |
|---|---|---|
| # of Promo Wks | ADD | MULT |
| (boundary = 7) | | HH |

Using the previous boundary definitions, the sample set can be visually represented by the above figure. Essentially, the sample set is split into three groups, each treated differently.

ADD model is used for slow movers, MULT is used for products with infrequent promotion in history, and HH is used for high promo fast movers.

Note: HH model is the causal model for the product-location level.

Gathering Data from WPD Product Tables

Input data for regression is read from WPD table.

In this stage we create a modified version of WPD that will make future tasks simpler; where:

Totaldollars=Regulardollars+Promodollars

Totaldemand=Promodemand+Regulardemand

Mediatype of null is replaced with 0 otherwise the original MT value is kept (promoflag)

Calculate a decay flag as 1 whenever there are two or more consecutive promo weeks and 0 otherwise

Join with the Product table to capture ClassXid information

Calculate Price=Totaldollars/Totaldemand

Remove weeks where the stockout flag in WPD is active

Essentially the weekly demand is divided by the seasonal factor SFi for that week.

Normalization is needed since aggregation of demand for several products is occurring.

Products have high/low demand with high/low prices. So, these need to be normalized for the Regression to be correct.

The demand is normalized by dividing the weekly demand by the average regular demand (done for each PDL):

$${NrmDemand}_{yrwk} = \frac{{Demand}_{yrwk}}{{AvgRegDmnd}_{PDL}}$$

The average regular demand is the averaged demand for weeks where the promoflag is 0.

Similarly the price can be normalized by:

$${Price}_{yrwk} = \frac{{Price}_{yrwk}}{{AvgRegPrice}_{PDL}}$$

Here, the log of the normalized demand is computed. However, as the weekly demand and consequently the normalized demand can have values of zero, the log transformation becomes problematic.

To solve this issue, 1.0 is added to each demand value and when normalizing, the ‘+1 Demand’ is divided by the average regular demand +1:

$${NrmDemand}_{yrwk} = \frac{{Demand}_{yrwk} + 1}{{AvgRegDmnd}_{PDL} + 1}$$

Now, it is possible to take the Log transform of the normalized demand.

Logarithmic and +1 transformation are used only for the MULT model.

ADD model does not require any transformation.

The possible aggregation combinations can be summarized as follows:

Aggregation Levels

| | Store (loc) | Nation (all locs) |
|---|---|---|
| CL2 | | |
| CL3 | | |
| CL4 | | |
| SKU | X | |

The SKU-Store combination is essentially the PDL level so it is ignored in this model. (this level is used for the high ARS, high promo items−HH model).

More levels of location (e.g. regions, districts) can potentially be added to the model, leading to more combinations.

Currently, there are two methods used for selecting the aggregation level.

Fixed Aggregation Level: In the first method, the aggregation level is fixed, say, Class 3 over all locations (nation).

Selective Aggregation Level: The second option follows a set selection criteria to select the aggregation level; e.g. pick the aggregation level with maximum R2 or aggregate until R2 is larger than a predefined threshold.

An issue is whether the aggregation data should be restricted within the MULT group or if data from the HH sector should be included as well. The former is default.

Once the aggregation level is chosen, the formed groups are processed by the residual outlier method and the mediatype analysis module.

These two procedures are almost identical to the ones found in the HH model. The only difference here is that they are executed over a group of PDLs rather than a single PDL.

For the MULT aggregation model multivariable regression is used whose parameters are the log of normalized demand, normalized price, mediatype groups, and decayflag:

$$\begin{matrix}y = log ( NrmDmnd ) \\ = a + b \times NrmPrice + {c}_{1} \times {MTGrp}_{1} + … + \\ {c}_{n} \times {MTGrp}_{n} + d \times Decayflag\end{matrix}$$

n is the number of mediatype groups. Currently, there can be up to 8 mediatype groups.

The uplift is calculated as:

L_{MULT}=e^{b(NrmPrice-1)}e^{c}^{ₓ} for the first promo week

L_{MULT}=e^{b(NrmPrice-1)}e^{c}^{ₓ}e^{d} for the remaining weeks in the promo

Cₓ represents the coefficient of the mediatype group that is active for a particular week.

Note: If a selective aggregation algorithm is employed that picks the aggregation level based on the maximum R2, for example, regression needs to be run 7 times, once for each aggregation combination. The lift is then calculated using the coefficients of the regression that has the maximum R2.

Due to the Aggregate UDF, performance is not a major issue.

For the ADD aggregation model, an SLR line with normalized demand and promoflag is used:

y=NrmDmnd=a+b×Promo

For this model, the uplift is

$${L}_{ADD} = \frac{a + b}{a}$$

Note: one uplift is calculated per aggregation group.

The final lifts are stored in an uplifts table. This table contains PDL, yrwk, and lift information. The lift column is 1.0 if there are no promotion for that week, and either L_{MULT} or L_{ADD} if a promotion exists.

From here, there are two methods to forecast:

In the DIRECT method, the lift for a particular week in the forecast period is selected from the above described uplifts table and is directly applied on top of the regular forecast. In this method, each week is treated as a full promotion week even if the product was on sale for just a day during that week. This method is used for tuning and testing.

In the Daily Weights (DW) method, we interface with the existing AR forecasting tool by populating the prdetail table with the appropriate lift for a certain promotion. However, as the name indicates, partial promo weeks are considered (during AR forecast run) by applying daily weights.

Embedded below is a schematic overview of the processing discussed at this point in time.

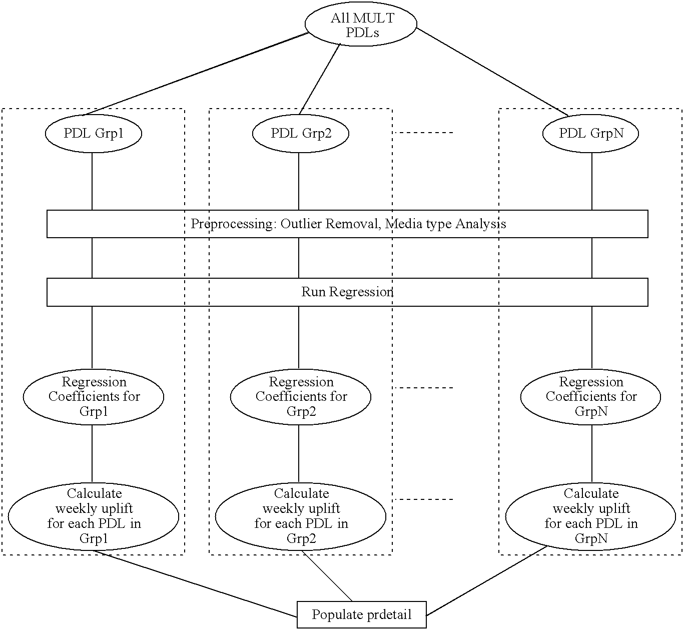

### HH Model

HH is a regression model for the product-location (PDL) level.

It deals with products with High ARS and High instances of promo in history.

The HH model is applied to all products with an ARS of greater than 3 and with the number of promo weeks in history greater than 7.

For HH model, the multivariable regression is run at the lowest PDL (SKU-Store) level, not at a class level.

The HH model documentation of three primary processing steps:
Causal Design—Preprocessing (Discussed first below)
Causal Design—Regression
Causal Design—Post processing

### Preprocessing

This is the first set for Preprocessing is outlined as follows:
Preprocessing for HH Model
   Extract data from WPD/Data Cleansing
      Out-of-stock removal
      Calculate promoflag
      Calculate decayflag
      Price Calculation
   Unit Price Calculation for Zero Demand Weeks
   Applying Seasonal Factors
   +1 and Log Transformation
   Outlier Detection and Removal
   Lag Calculations
   Media Type Analysis
Output of Preprocessing

Preprocessing follows a specific sequence of actions. The order by which the SQL statements are executed is significant, and is shown:

| Constraint | Reason |
|---|---|
| Unit price should be | Unit price cannot be calculated |
| calculated after | when demand is zero |
| removing zero- | |
| demand or out of | |
| stock weeks (next | |
| slide) | |
| Unit price should be | Actual demand and revenue |
| calculated before | should be used for this calculation |
| applying the seasonal | not the adjusted ones |
| factors | |
| +1 transformation | Log of demand cannot be |
| before applying the | calculated when demand is zero. |
| LOG transformation | That is why +1 transformation is |
| | applied. |
| Seasonal factors | SF's are only valid for actual |
| should be applied | demand (when the dimension of |
| before log | demand is UNIT) |
| transformation | |
| Outliers should be | Outlier detection should be applied |
| detected and removed | to the same values that are used |
| after all the | for the regression (a data point that |
| transformations are | appears as an outlier before log |
| done. | transformation may lie with the rest |
| | of data after the transformation) |
| Media type analysis | The analysis should be done on |
| (calculation of the | the same values that are used for |
| weight of each media | the regression. |
| type) should be done | Unlike SF and log transformation, |
| after the outliers are | this analysis can be done after the |
| removed. | outlier detection, since it does not |
| | change the value of variables, and |
| | hence does not affect outlier |
| | analysis. Outliers, however, affect |
| | the results of the media type |
| | analysis |
| Calculation of decay | Even if we remove a week that is |
| flag must be before | on promo as an outlier we should |
| outlier removal | flag the week after as DECAY |

1. Extract Data from WPD
   a. Zero week and out-of-stock removal (†)
   b. Promoflag
   c. Decayflag
   d. Price calculation
2. Unit price calculation for zero demand weeks
3. Applying seasonal factors
4. Transformations
   a. +1 transformation
   b. Log transformation
5. Outlier detection and removal
6. Lag calculation
7. Media type analysis
8. Check the quality of data. Detect and remove the variables that lead to singularity
   a. Unchanged variables
   b. Dependency test
   c. Number of variables vs. number of weeks criteria
9. Call the UDF (Regression)

Missing weeks and zero demands in the WPD are dealt with differently:

Historical sales data, extracted from WPD table, is input to the multi-variable regression for causal analysis and forecasting.

The proposed technique deals with:
Missing weeks in the WPD
Zero-demand weeks
Stock outs
Highly seasonal or event driven products (not available for some weeks of the year)

Also the technique provides for calculation of unit price, lags and decay flags for the above cases.

Missing weeks/zero demands can be a consequence of different factors:

The product is not available for certain weeks (e.g. seasonal or event-driven products):

These products are analyzed in advanced by the Profile module of TDCM. The periods of time when the product is not available is marked (e.g. SF=b 0) and removed from the regression model.

Stock-outs: the product is not available on the shelf.

“stockoutind” and “inventory” fields of WPD can be used to identify stock-outs.

No demand: the product is available but there was no demand (e.g. slow mover items).

The following procedure is proposed:

Missing weeks are not filled.

There is no data available to determine why the week is missing.

By filling the weeks extra weight is added on some of the data points.

Zero demands are excluded from the calculations only if

inventory=0 OR stockoutind=1.

The period of time for which the product is not available (due to seasonality) is removed. There periods are marked in advanced as SF=0.

Detect and remove the outliers: if the item is not actually a slow mover (the demand of the rest of the weeks is high) then the week(s) with zero demand will be detected as outlier.

Unit Price:

The unit price cannot be calculated for weeks with zero demand (it is typically calculated as totaldollar/totaldemand). Average price will be used depending on promoflag.

| | | Avg. | Avg. | |
|---|---|---|---|---|
| | | Regular | Promo | |
| Price | 11 | Price | Price | 15 |
| Promo | 0 | 0 | 1 | 0 |
| dmnd | 5 | 0 | 0 | 2 |
| ypw | 200602 | 200603 | 200604 | 200605 |

Decay Flags

Missing weeks are ignored for calculation of decay flag (ypw data is not used). So the flags are calculated based on the sequence of the available data.

| | | | | |
|---|---|---|---|---|
| decay | 0 | 0 | 1 | 0 |
| Promo | 0 | 1 | 1 | 0 |
| ypw | 200620 | 200621 | 200626 | 200627 |

Lag1, lag2 and lag3:

Missing weeks are ignored for calculation of these lags (ypw data is not used). So the lags are calculated based on the sequence of the available data.

| | | | | |
|---|---|---|---|---|
| lag2 | . . . | . . . | 31 | 38 |
| lag1 | . . . | 31 | 38 | 34 |
| dmnd | 31 | 38 | 34 | 39 |
| ypw | 200620 | 200621 | 200626 | 200627 |

Lag52

Lag52 is calculated using ypw data. If the corresponding week does not exist then the closest week will be used.

| | | | | | |
|---|---|---|---|---|---|
| lag52 | . . . | . . . | . . . | . . . | 39 |
| dmnd | 31 | 38 | 39 | . . . | 48 |
| Ypw | 200524 | 200525 | 200528 | . . . | 200627 |

Continuing with the discussion of preprocessing: Input data for regression is read from the WPD table and stored into a temporary table.

In this stage create a modified version of WPD:

Remove weeks where the stockout flag in WPD is active.

Remove weeks where inventory is <0 (optional).

Remove weeks that are greater or equal to the beginning of the forecast period.

Mediatype of null is replaced with 0 otherwise the original MT value is kept.

Calculate a decay flag as 1 whenever there are two or more consecutive promo weeks and 0 otherwise.

Create the field TotalDollars=Regulardollars+Promodollars.

Create the field TotalDemand=Regulardemand+Promodemand.

Calculate AvgPrice as TotalDollars/TotalDemand when demand is not zero. Otherwise, price is zero.

In step 1, the “problem weeks” for price calculation were tagged with a zero price value.

Since the price cannot be calculated when the demand is zero, an average will be employed.

For such a week,

if promoflag=0 then the Average Regular Price will be used to fill in price.

If promoflag=1 then the Average Promo Price will be used to fill in price.

If Average Promo Price is also zero then Average Regular Price will be used.

Sales data are seasonally adjusted for forecast calculation by dividing the weekly demand by the seasonal factor (SFi) for that week.

After deseasonalized the sales data (step 3), a value of one unit (+1.0) is added to all the demand values.

This is to avoid zero sales and be able to calculate the natural logarithm of demand (reminder: LN(0)=−infinity).

The following equation summarizes all the three transformations (SF, +1 and LOG) applied on the demand:

$$y = log ( \frac{{Dmnd}_{yrwk}}{{SF}_{wk}} + 1 )$$

For weeks where the deseasonalized demand is less than zero, the log transformation of the demand is set to zero.

There are 2 methods for outlier detection and removal:

The 3 Sigma Method

The mean and standard deviation of the deseasonalized demand is calculated.

Any point that is more than 3 standard deviations away from the mean yields an outlier

The Residual Outlier Method (recommended in an embodiment).

The preferred method of outlier detection is the Residual Outlier method. Here, a linear regression based on Price is fitted as:

$$y = log ( \frac{{Dmnd}_{yrwk}}{{SF}_{wk}} + 1 ) = a + b \times price$$

It is assumed that the demand was deseasonalized and transformed as explained in steps 3 and 4 above.

Now any point that is more than 3 standard deviations away from the line yields an outlier

Lagxx refers to the demand value xx weeks ago.

It can be used (optionally) to model seasonality (lag52) or recent sales patterns (lag1,lag2,lag3).

Note, lag52 is generally not used since we deseasonalize using SFs.

Lag52 cannot be calculated until there is at least one year of history in the WPD for the PDL.

For all records which have less than one year of history, the demand of the first year week (minyrweek) of that PDL is used as its Lag52 value.

For example, if the minyrweek for a PDL is 200323, no true lag52 is available until 200423 whose lag52 is 200323. The period from 200323 to 200422 is filled with the demand value for 200323.

When going back 52 weeks for lag52, that particular week may be missing. In those cases the closest available week from the missing week is chosen.

A similar algorithm is used for the other lags 1, 2, etc..

More details on Lag calculation when dealing with missing weeks or zero demand can be found here:

Historical sales data, extracted from WPD table, is input to the multi-variable regression for causal analysis and forecasting.

We use a technique to deal with:
Missing weeks in the WPD
Zero-demand weeks
Stock outs
Highly seasonal or event driven products (not available for some weeks of the year)

Also we use a technique for calculation of unit price, lags and decay flags for the above cases.

Missing weeks/zero demands can be a consequence of different factors.

The product is not available for certain weeks (e.g. seasonal or event-driven products):

These products are analyzed in advanced by the Profile module of TDCM. The periods of time when the product is not available is marked (e.g. SF=0) and removed from the regression model.

Stock-outs: the product is not available on the shelf

“stockoutind” and “inventory” fields of WPD can be used to identify stock-outs.

No demand: the product is available but there was no demand (e.g. slow mover items).

The following procedure is used in an embodiment.

Missing weeks are not filled.

There is no data available to determine why the week is missing.

By filling the weeks we add extra weight on some of the data points that would lead to less accurate results.

Zero demands are excluded from the calculations only if

inventory=0 OR stockoutind=1.

The period of time for which the product is not available (due to seasonality) is removed. There periods are marked in advanced as SF=0.

Detect and remove the outliers: if the item is not actually a slow mover (the demand of the rest of the weeks is high) then the week(s) with zero demand will be detected as outlier.

Unit Price:

The unit price cannot be calculated for weeks with zero demand (it is typically calculated as totaldollar/totaldemand). Average price will be used depending on promoflag.

| | | Avg. | Avg. | |
|---|---|---|---|---|
| | | Regular | Promo | |
| Price | 11 | Price | Price | 15 |
| Promo | 0 | 0 | 1 | 0 |
| dmnd | 5 | 0 | 0 | 2 |
| ypw | 200602 | 200603 | 200604 | 200605 |

Decay Flags

Missing weeks are ignored for calculation of decay flag (ypw data is not used). So the flags are calculated based on the sequence of the available data.

| | | | | |
|---|---|---|---|---|
| decay | 0 | 0 | 1 | 0 |
| Promo | 0 | 1 | 1 | 0 |
| ypw | 200620 | 200621 | 200626 | 200627 |

Lag1, lag2 and lag3:

Missing weeks are ignored for calculation of these lags (ypw data is not used). So the lags are calculated based on the sequence of the available data.

| | | | | |
|---|---|---|---|---|
| lag2 | . . . | . . . | 31 | 38 |
| lag1 | . . . | 31 | 38 | 34 |
| dmnd | 31 | 38 | 34 | 39 |
| ypw | 200620 | 200621 | 200626 | 200627 |

Lag52

Lag52 is calculated using ypw data. If the corresponding week does not exist then the closest week will be used.

| | | | | | |
|---|---|---|---|---|---|
| lag52 | . . . | . . . | . . . | . . . | 39 |
| dmnd | 31 | 38 | 39 | . . . | 48 |
| Ypw | 200524 | 200525 | 200528 | . . . | 200627 |

Lags are optional variables that may or may not be used in regression models.

Media Type Analysis

The purpose of media type analysis is to distinguish the effect of different promotions, such as newspaper advertising or flyers, on demand.

Certain media types generate similar increases in demand and hence can be grouped together into the same category.

Media type analysis has 2 steps:

Create Media type groups.

Use the Media groups as new variable(s) in the Multi-regression.

Details of media type analysis is described in the following:

$$y = log ( \frac{{Dmnd}_{yrwk}}{{SF}_{wk}} + 1 ) = a + b \times price$$

Calculate the residual mean as:

ResidualMean_{PDL,MT}=AVG(demand−(a+b×price))

Calculate the confidence interval as:

$${Conf}_{PDL , MT} = 1.64 \times \frac{STDEV ( demand - a + b \times price )}{\sqrt{n}}$$

The confidence interval can be tuned (change value 1.64).

In an embodiment, the confidence interval is 95%.

The tuning of the confidence interval is further explained below:

The confidence interval (CI) can be used to determine if media types can be grouped together.

Media types are sorted by mean of residuals (RM) in descending order per PDL.

There is overlap when RM1−CI1<RM2+CI2.

On a PDL basis, Media Types are placed into the same group if their confidence intervals overlap.

Next, the categorical type variable group number is transformed into a numerical value with meaning as:

$${AvgDemand}_{Grp} = \frac{\sum {AvgDemand}_{Grp , MT} \times {NumPts}_{Grp , MT}}{\sum {NumPts}_{Grp , MT}}$$

This is again done on a PDL basis.

The final weight for each group per PDL is determined by:

$${Weight}_{Grp} = \frac{{AvgDemand}_{Grp} - AvgRegDemand}{{AvgDemand}_{Grp = 1} - AvgRegDemand}$$

Now each media type value in the temporary WPD should be replaced with its corresponding weight as calculated above.

The calculated weights are used as a regression variable that represents promos and media types.

More information on weight calculation can be found here:

Media types are codes or labels (from 0 to 99) indicating the advertisement methods; where 0 indicates no advertisement (regular sales) and other labels show different (combination of) advertisement methods.

Teradata Demand Chain Management is developing a multivariable regression model that can be used for calculation of promo uplift or demand forecasting.

It is desired to use the media type information to improve the regression model. That is, adding new variable(s) to the regression equation to account for the media types.

The typical regression equation in the absence of media types is:

y=a+b.promoflag+c.price+

where y is demand, promoflag is a binary flag indicating whether there is a promotion, price is the unit price, and a,b and c are the regression coefficients.

Standard procedure: media types are logistic variables. Normally one regression variable must be defined for each category of the logistic variables.

$$y = a + {\sum }_{i = 1}^{n} {b}_{i} \cdot {promoflag}_{i} + c \cdot price + …$$

where promoflagi is a binary flag corresponding to the media type i, and bi is the regression uplift for that media type.

Problem: The increased number of variables causes various numerical problems, including increased computational time, and data scarcity issues.

Proposed Solution: a novel technique is proposed to transform the logistic variables (media type) into numerical values (one numeric variable).

The regression equation can be defined as

y=a+b.promoi+c.price+

where

i: refers to the media type

promoi: is the numeric variable (weight) for the media type i

Notes:

b. promoi is the regression estimator (est1) for the additive promo uplift. It has the same dimension as y (e.g. units of product when y is demand).

b.promoᵢ=est₁(liftᵢ)

b is the regression coefficient (the base uplift) and is constant for all media types. It has the same dimension as y (e.g. units of product when y is demand).

promoi is a multiplicative coefficient that determines the weight or the relative effect of the media type i. This coefficient is dimensionless.

Key: the key for deriving the mathematical formulation is the calculation of promo weights, promoi, for each media type.

The promo weights are to be calculated first and fed to the regression model. Hence an additional relation (next to the regression equation) is required. This relation is derived using the following assumption.

Assumption: the change in the average demand due to a media type is a sufficient estimator (est2) for calculation of promo weights (the relative effect of the media types).

y̅ᵢ− y̅₀=est₂(listᵢ)
where y̅ᵢ is the average sales for media type i
and y̅₀ is the average regular sales

Note1: The above relation is generally applicable for transforming the logistic variables into numerical ones. It may potentially be replaced by more accurate relations that are applicable to particular cases.

Note2: The above estimator (est2) is not as accurate as the regression estimator (est1) so it is only used for calculation of the weights (relative effects). The actual uplift, b, is calculated through the regression model.

$$The relations \text{:}$$

$$\{ \begin{matrix}b \cdot {promo}_{i} = {est}_{1} ( {lift}_{i} ) , i = 1 , 2 , … , n \\ {\overline{y}}_{i} - {\overline{y}}_{0} = {est}_{2} ( {lift}_{i} ) , i = 1 , 2 , … , n\end{matrix}$$

form a system of n (number of media types) equations for which b and promoi are unknown.

The values of promoi should be calculated in advanced and then fed into the regression model where b is calculated.

This system of equations is “underdetermined”, since there are n equations and n+1 unknowns, so set promoi=1.

$$\begin{matrix}\begin{matrix} \\ {promo}_{1} = 1\end{matrix} \} ⇒ b = {est}_{1} ( {lift}_{1} ) \\ b \cdot {promo}_{i} = {est}_{1} ( {lift}_{i} ) ⇒ {promo}_{i} = \frac{{est}_{1} ( {lift}_{i} )}{b}\end{matrix} \} ⇒ {promo}_{i} = \frac{{est}_{1} ( {lift}_{i} )}{{est}_{1} ( {lift}_{1} )} = ( \frac{{lift}_{i}}{{lift}_{1}} )$$

Here are some examples:

$$\{ \begin{matrix}y = a + b \cdot {promo}_{i} + c \cdot price + … \\ {promo}_{i} = \frac{{\overline{y}}_{i} - {\overline{y}}_{0}}{{\overline{y}}_{1} - {\overline{y}}_{0}}\end{matrix} \\ \{ \begin{matrix}i = 1 \text{:} \\ y = a + b \cdot \frac{{\overline{y}}_{1} - {\overline{y}}_{0}}{{\overline{y}}_{1} - {\overline{y}}_{0}} + c \cdot price + … = a + b + c \cdot price + … \\ ( b is the base additive uplift calculated by the regression model )\end{matrix} \\ \{ \begin{matrix}i = 2 \text{:} \\ Assuming that the effect of media type 2 is k \% more significantly than media type 1 \\ {lift}_{2} = ( 1 + k ) {lift}_{1} ⇒ {\overline{y}}_{2} - {\overline{y}}_{0} = ( 1 + k ) \cdot ( {y}_{1} - {y}_{0} ) \\ y = a + b \cdot \frac{{\overline{y}}_{2} - {\overline{y}}_{0}}{{y}_{1} - {y}_{0}} + c \cdot price + … = a + b \cdot \frac{( 1 + k ) \cdot ( {\overline{y}}_{1} + {\overline{y}}_{0} )}{{\overline{y}}_{1} - {\overline{y}}_{0}} + c \cdot price + … \\ y = a + b \cdot ( 1 + k ) + c \cdot price + … \\ ( the uplift term will be k \% larger than the base uplift \text{-} uplift of media type 1 )\end{matrix}$$

The figure above shows actual data (demand, price and media type) for a sample product.

Media type 7 (week 100) is significantly different than media type 6 (rest of data).

Blue data points are analyzed by the regression model to forecast for the last 13 weeks (red data points).

The figure above compares the forecast results versus the actual sales for the last 13 weeks of the data (marked in red in the last figure).

Green dashed line uses the media type information (new model) while red dashed line does not distinguish between the media types.

Even though all the promos during the forecast period are of the same kind (media type 6) the new model results in an improvement of more than 20% in forecast error and 30% in regression R2.

The technique documented here is generally applicable. It was used to model the effect of media types in the regression equation, but it can be employed to transform any set of logistic variables into a numeric one, and hence avoid increasing the number of regression variables.

The assumption used here for calculation of the uplifts from average sales (est2) is generally applicable. Better relations however may be derived for particular cases. For instance, a more accurate relation can be derived by removing the effect of other parameters in est2. This can be done by using a preliminary regression model and replacing demand average with residual average.

Theoretically the choice of media type 1 (base) is arbitrary. However, from the numerical perspective it is recommended to choose the media type with the largest uplift as the base, since it reduces the chance of dealing with small denominators.

The technique presented here is applicable when the response variable, y, is transformed. Transformation of y is often required to improve the accuracy of the regression model. Typical transformations are deseasonalizing (applying seasonal factors) and logarithmic transformation.

After preprocessing is complete. The data is stored in the table loadlocnreg.

The table contains the calculated regression variables, i.e. demand, price, promoflag, decayflag, Lag1, Lag2, Lag3 and Lag52 values for each PDL for every yearplusweekno which has not been removed as an outlier. (Note that the number of variables may be different from case to case.)

Data from this table is used to call the Regression UDF.

Preprocessing requires various temporary tables to be created.

Scripts create all the temporary tables needed for preprocessing.

It also fills in the tables yearweekseq and wmsfpivot.

Preprocessing is executed in the procedure AEU_Preprocessing_IPL.

The procedure takes as its parameters:
(applySF, logs, outlier, applyMt, begFcstPeriod)
   applySF
   0 to not apply seasonal factors
   1 to apply seasonal factors
   logs
   0 to not apply log transformation
   1 to apply log transformation
   outlier
   0 to not remove outliers
   1 to apply 3 sigma method
   2 to apply residual outlier method
   applyMt
   0 to not apply media types
   1 to apply media types
   begFcstPeriod
   Beginning of forecast period

Again it is reiterated that the HH model (causal framework for PDL level) consists of 3 primary processing steps:
Causal Design—Preprocessing
Causal Design—Regression (Discussed in detail now)
Causal Design—Postprocessing

### Regression

The idea behind regression is to develop a causal model to:
Establish a cause-effect relationship between demand and the potential influencing factors
Calculate promotional uplift and demand forecast based on the casual relationship

Demand is the response variable.

Price, Promoflag, and Decayflag are some examples of causal variables.

The number of causal variables can range from one to many.

Regression generates the best fit line to relate the response variable with the causal variables.

Demand estimates can then be made using the regression line and the causal variables.

In order to perform this analysis two UDFs are created.

An aggregate UDF is created to:
collect and summarize data for all preprocessed PDLs
perform Multi-variable regression
yield one output per PDL

An tabular UDF is created to:
Take as input, the output from the aggregate UDF
Transform the output of aggregate UDF into a tabular format
Output the coefficients of the causal variables for each PDL

Before Regression can take place, 3 tests are conducted on preprocessed data to detect and remove data that lead to singularity.

These tests ensure:
Quality of Regression Equation
Performance of Aggregate UDF

### Test 1: Unchanged Variables

Variables which are constant during the available history are removed.

Not removing constant variables will lead to singular matrix.

### Test 2: Dependency and Redundancy Check

The test of dependency and Redundancy should be conducted after removing constant variables (Test 1).

If dependent or redundant variables are not removed, it may lead to singular matrix.

Note: A set of vectors {v1, v2, . . . , vm} is linearly independent if the only solution to the vector equation λ1.v1+λ2.v2+ . . . +λm.vm=0 is λi=0 for all i.

Note: Redundancy is removed in Excel linest( ) and MATLAB regress( ).

More theoretical background and the details of the calculation for dependency/redundancy checks can be found here:

We need to perform three tests on the regression input data.
1. test and remove constant variables
2. test the dependent variables—remove one arbitrarily
3. test the relation between # of weeks and # of variables

Challenge: we decided to implement an aggregate UDF for regression. An aggregate UDF reads and processes input data record by record (one week of data at a time), and hence it does not have access to the previous data (previous records). This makes conducting the above tests challenging, since they typically require all the data.

Solution: this document shows an innovative process that can test dependency of the input variables with no need to store the previous data.

Definition:

A set of vectors {v1, v2, . . . , vm} is linearly independent if the only solution to the vector equation λ1.v1+λ2.v2+ . . . +λm.vm=0 is λi=0 for all i.

For our case the vector vm corresponds to variable m of the regression model.

Proposed Method:

One pair of variables (e.g. vi and vm) is tested at a time. This results in total combinations of m*(m−1)/2 pairs to be tested.

It can be shown that for the equation λi.vi+λj.vj=0 either λi=0 for all i (independent variables) or vi1/vj1=vi2/vj2= . . . =vin/vjn=−λj/λi=k for any non-zero elements of vi and vj (dependent variables). In other words, the two vectors are dependent only if all the elements of first vector is k times the corresponding elements of the second vector.

So for any give pair of variables we need to test the ratio of the corresponding elements. If all the ratios are equal the variables are dependant, otherwise they are independent.

Read the row x of the input data (one row at a time)

Calculate the ratio rij=vix/vjx for each pair of variables

Update the statistic S=[max(rij)−min(rij)]/mean(rij) for each ij combination (this is done without storing the previous rij data).

Repeat steps 1-3 for all the rows of the input data.

Test the statistic S. If it is smaller than a constant minimum (i.e. C=0.01) then the pair of variables i are dependent. Remove one arbitrarily.

The magnitude of the constant minimum C defines the stability of the model. C is the percentage deviation from the full dependency that is needed to keep a variable in the model. When C is large more variables are removed from the model and the model is more stable. Generally, larger values may be needed when the number of variables is high since close to singular matrices combined with round off error may lead to unstable numerical scheme.

The ratio rij cannot be calculated when both of the corresponding elements are zero. In this case the calculation is skipped (the statistic S need not to be updated). If only one of the elements is zero, however, the two variables are independent (S=large number).

The test of dependency should be done after removing the constant variables. (In aggregate UDFs the calculation of S and test of the constant variables is done at the same time, when data is being read. But the comparison of S and C—variable removal—should be done after constant variables are removed.)

Further analysis showed that dependency check is not sufficient for regression. In fact redundant variables are not necessarily dependent. See the attached Excel file for details.

Redundancy should be removed too, otherwise it leads to singular matrix.

This is done in both Excel linest( ) and MATLAB regress( ). linest( ) removes a redundant variable but regresso( ) removes the first variable—intercept. They both lead to the essentially identical models. myregress( ) function that does not remove any variables lead to singular matrix.

Test 3: Number of Variables vs. Number of Weeks Criteria

The quality of the regression equation depends on the amount of data history available.

More causal variables will require more weeks of history.

The following ratio must be met:

$$\frac{WksHist}{numVariables} > 10$$

If the ratio is not met, causal variables must be removed from the right hand side of the active list (least significant) until the ratio is satisfied.

UDF can now be run

The aggregate UDF was used for regression because it provides the concept of grouping records together, unlike the typical row-by-row processing of the Tabular and Scalar UDFs.

There is less Confusion/Setup to actually run a regression function.

No need to pack variables into varbytes.

Large Performance Gains

No added overhead of pivoting and shifting large amounts of data to form single SKU records.

No Oversized/Large Rows

Parallel efficiency using distribution

UDF name: dcm_sci_udf_agr_calc

UDF type: Aggregate (n inputs→1 output (varbyte))

Takes as its parameters:
An active list of 20 characters (0 or 1)
0 indicates to exclude factor (inactive)
1 indicates to include factor (active)
First active factor is considered the response variable

All following factors are causal variables.

Active List is followed by names of actual variables in the same sequential order.

Currently: demand is response variable; and price, promoflag and decayflags are the active causal variables.

Data is summarized on a SKU level.

A multi-variable regression equation is calculated for each PDL.

Coefficients for each of the variables in the active list is output as a single varbyte for each SKU preprocessed.

```
    The output data is saved in the table glb_agr_var_out
    select l.locationid, l.productnumber,
        dcm_sci_udf_agr_calc(
        ‘000111100000000000000’, [symbol]  ACTIVE LIST
        CAST(l.locationid AS FLOAT),
        CAST(l.productnumber AS FLOAT),
        CAST(l.yearplusweekno AS FLOAT),
        CAST(l.demand AS FLOAT), CAST(l.price AS
FLOAT),
        CAST(l.promoflag AS FLOAT), CAST(l.decayflag
AS FLOAT)
        ,CAST(l.lag1 AS FLOAT),0,0,0,0,0,0,0,0,0,0,0,0 )
    from loadlocnreg l
    group by l.locationid, l.productnumber ; [symbol]  Define our
groups
```

Response is Underlined/PREDICTORS are Bold

After running aggregate UDF, data is packed into large varbyte structures for PDL.

Results should be transformed into a table structure for calculation of uplifts (post-processing).

Tabular UDF is needed to parse the output from the aggregate UDF, such that the 20 calculated regression coefficients can be stored in columns in a table.

UDF name: dcm_sci_udf_decript

UDF type: Tabular (1 input (varbyte) n outputs (decrypt varbyte))

Takes as its parameters:
Output from Aggregate UDF
Locationid
Productnumber
varbyte

Outputs the decrypt coefficients corresponding to the active list for each PDL.

Coe1 is the coefficient for the response variable.

Coe2-Coe20 are the coefficients for the causal variables.

Data is stored in the table agr_sci_out.

Next step is Post-processing, that uses the regression coefficients to calculate the uplifts.

Regression and Tabular UDF is executed in the procedure test_agr_udf

This procedure does not have any parameters

Once again, the HH model (causal framework for PDL level) consists of 3 processing steps:
Causal Design—Preprocessing
Causal Design—Regression
Causal Design—Postprocessing (the immediate discussion that follows now)

### PostProcessing

The Coefficient of Determination R2 is useful in determining the “goodness of fit” for the regression line.

Calculation of Regression R2:

$$\begin{matrix}{R}^{2} = {[ Correl ( X , Y ) ]}^{2} \\ = {[ \frac{\sum ( x - \overline{x} ) ( y - \overline{y} )}{\sqrt{\sum {( x - \overline{x} )}^{2} \sum {( y - \overline{y} )}^{2}}} ]}^{2}\end{matrix}$$

This statistic is calculated for each PDL and in case where the denominator is zero, R2 is set to −1.

When we determine that X or Y is not changing by much (i.e. (SETmax−SETmin)/SETavg<0.01) we set the R2 value to −1).

The results are stored in sci_reg_stats.

This table also contains a promoweeks column which represents the number of promotion weeks in history.

Two approaches are available for calculating promo forecasts:

Direct Method

This method calculates one promo uplift for each weak of the forecast period, and applies that to the regular forecast previously calculated and stored in LPF table.

Regular forecast=ARS*SF

Total forecast=(ARS*SF)*uplift

This is a fast approach and is preferred for testing purposes.

Daily Weight Method

This method stores the uplifts by populating prdetail table, which is an input to AR forecasting.

Then AR forecast reads the uplifts from prdetail and calculates regular and total forecasts (while applying daily weights).

Daily weight method will be used in practice for forecasting.

The value of causal variables, i.e. price, promoflag, decayflag, for each PDL for each week of the forecast period is stored in the future_weeks table.

In practice, this data is to be retrieved from different sources, e.g. future promo data is retrieved from the prpromotion table, and future price is assumed to known.

In the current prototype, however, this data is calculated form WPD, for the weeks corresponding to the forecast period.

Calculation of future values of the variables (specifically Price) is different for direct and daily weight methods, as described the following slides.

| | product- | | | |
|---|---|---|---|---|
| locationid | number | yearplusweekno | mediatype | promosessionid |
| 2274 | 1 | 200535 | ? | 0 |
| 2274 | 1 | 200536 | ? | 0 |
| 2274 | 1 | 200537 | 8 | 1 |
| 2274 | 1 | 200538 | 8 | 1 |
| 2274 | 1 | 200539 | 8 | 1 |
| 2274 | 1 | 200540 | 3 | 2 |
| 2274 | 1 | 200541 | 5 | 3 |
| 2274 | 1 | 200542 | 5 | 3 |
| 2274 | 1 | 200543 | ? | 0 |
| 2274 | 1 | 200544 | ? | 0 |
| 2274 | 1 | 200545 | 8 | 4 |
| 2274 | 1 | 200546 | 8 | 4 |

The table contains the PromoSessionID column which is used to differentiate promotions based on their media type and time of occurrence.

For each promotion session we will attempt to calculate the average net promo price, that is, AVG(promo$/promoDmnd) and use it throughout that particular promotion session.

It is evident from the previous price definition that we could end up with a zero denominator when the promo demand is zero. In that case we will ignore that week and attempt to calculate the average on the remaining weeks within the promo session.

If the above procedure fails, the alternatives for the promotion session price in order of selection will be:

Historical net promo price for the corresponding media type.

Historical overall net promo price.

Historical average regular price (this reduces PriceX to 1).

These steps are illustrated next.

Full promo price is calculated.

$$price = avg \frac{{promoDollar}_{i}}{{promoDemand}_{i}} for session i$$

The following schematic is used when promoDemand=0

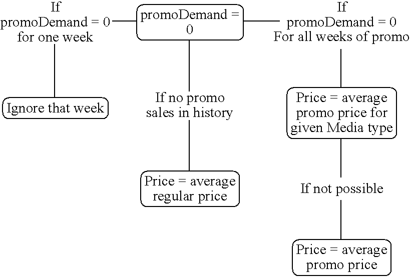

Promoflag calculation is shown in the flowchart:

When it is decided not use media types (mainly for testing purposes) the promo flag is a binary variable.

Decay flag is set to 1 whenever there are two or more consecutive promo weeks and 0 otherwise.

Finally for both methods, weeks where promoflag=0 is removed from the future_weeks table.

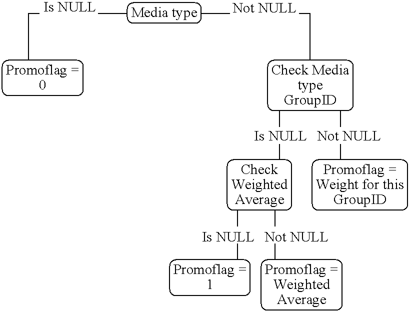

In the daily weight method, price for the PDLs in the forecast week is determined on promo session basis.

In the direct method, price is determined on a weekly basis.

Uplifts calculated by direct method are applied without running AR.

Price calculation is summarized in the following flow chart:

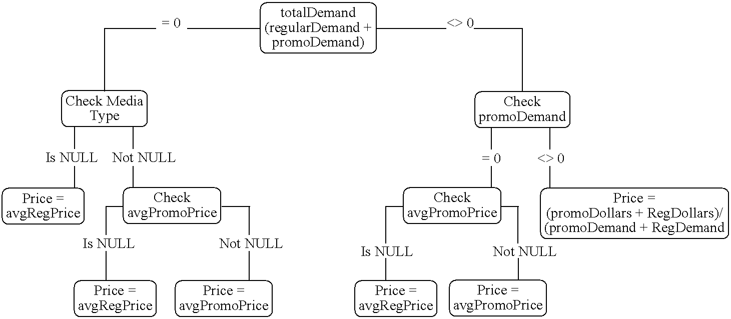

Promoflag calculation is shown in the flowchart:

When it is decided not use media types (mainly for testing purposes) the promo flag is a binary variable.

Decay flag is set to 1 whenever there are two or more consecutive promo weeks and 0 otherwise.

Finally for both methods, weeks where promoflag=0 is removed from the future_weeks table:

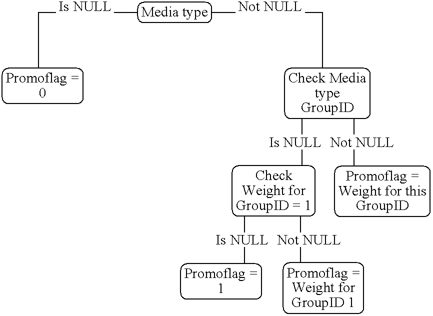

Uplift calculations for weeks in history are executed in the procedure sci_post_processing.

Outputs for uplift calculation is stored in the table sci_mult_uplifts.

Inputs are from tables

loadlocnreg

Final table after preprocessing

agr_sci_out

Final table after running aggregate and tabular UDF

Contains coefficients of regression variables for each PDL

sci_reg_stats

Table containing regression statistics R2 and promo weeks in history The uplift is calculated as.

$$\begin{matrix}{L}_{i} = {PriceX}_{i} \times {PromoX}_{i} \times {DecayX}_{i} \\ = {e}^{b ( {Price}_{i} - AvgRegPrice )} \times {e}^{c \cdot {PromoFlag}_{i}} \times {e}^{d \cdot {DecayFlag}_{i}}\end{matrix}$$

When the lift is greater than 10 we examine the R2 and promo weeks in history (p).

If R2>0.3 and p>5 then we accept the large lift but cap it at 10.

Otherwise we use the lift of 1 (assumed to be a wrong lift).

There is also a lower limit for the lift which is 0.2.

That is, if we calculate a lift that is less than 0.2 we adjust the lift to 1.

The lift values are stored in sci_mult_uplifts.

Uplift calculations for weeks in the forecast period are executed in the procedure sci_mult_uplifts_future.

Inputs are from tables

future_weeks

Table containing causal values i.e. Price, promoflag, decayflag for weeks in forecast period.

agr_sci_out

Final table after running aggregate and tabular UDF

Contains coefficients of regression variables for each PDL.

sci_reg_stats

Table containing regression statistics R2 and promo weeks in history.

The uplift calculations follow the same steps as discussed above.

The same caps are also employed.

The uplift values for future weeks are added onto the table sci_mult_uplifts.

Prdetail Contains

Column with PromotionIDs which in purpose is similar to PromotionSessionIDs used earlier.

13 columns all used for lift information (1st lift column for the first week of promo, 2nd column for the second week of promo, etc).

Prpromotion Contains

information about the effective period (start/end dates) of the promotion.

Media Type Used.

Now the filling scheme leverages the above information from prdetail on migrosprod but replaces the lifts found in the prdetail with the ones stored in sci_mult_uplifts and places them in the prdetail table on the test database.

The first week lift of the promotion is looked up from sci_mult_uplifts using the effectivedate stored in prpromotion. All other lift columns of the same promotion will contain the first lift multiplied by the decay factor.

Note: direct method does not fill prdetail.

The previously mentioned price calculations were our best estimate as to what the actual promotion price should have been at a particular future week (week of forecast period). This was necessary as the actual promotion prices were not available at the time of testing.

In practice, however, the system will be supplied with the actual promotion prices, eliminating any estimating work on our part. This greatly simplifies the calculation of the PriceXterm mentioned earlier.

Similarly the future promotion data is to be retrieved from prpromotion table, rather than WPD.

In order to populate the lift columns in prdetail the three required parameters are PriceX, PromoX, and DecayX.

The first week of promotion will contain a lift of PriceX*PromoX

and the remaining weeks are filled with PriceX*PromoX*DecayX.

Max and Min limits on the uplift will still be enforced as mentioned earlier.

Regression statistics of calculating R2 and promotional weeks in history are executed in the procedure sci_gen_reg_stats.

This procedure has no parameters.

Populating future_weeks can be 1 of 2 methods

Daily Weight Method.

future_weeks is populated by the procedure sci_future_weeks

Parameters (applyMT, begFcstPeriod, endFcstPeriod)

Direct Method

future_weeks is populated by the procedure sci_future_weeks_DM

Parameters (applyMT, begFcstPeriod, endFcstPeriod)

Code for sci_future_weeks_DM is here:

Calculating uplifts for weeks in history are executed in the procedure sci_post_processing

Parameter (logs)

Calculating uplifts for weeks in the forecast period are executed in the procedure sci_mult uplifts_future

This procedure has no parameters.

prdetail is populated in the procedure sci_pop_prdetail

This procedure has no parameters.

It is within this detailed context that a few specific embodiments are claimed herein and discussed in detail.

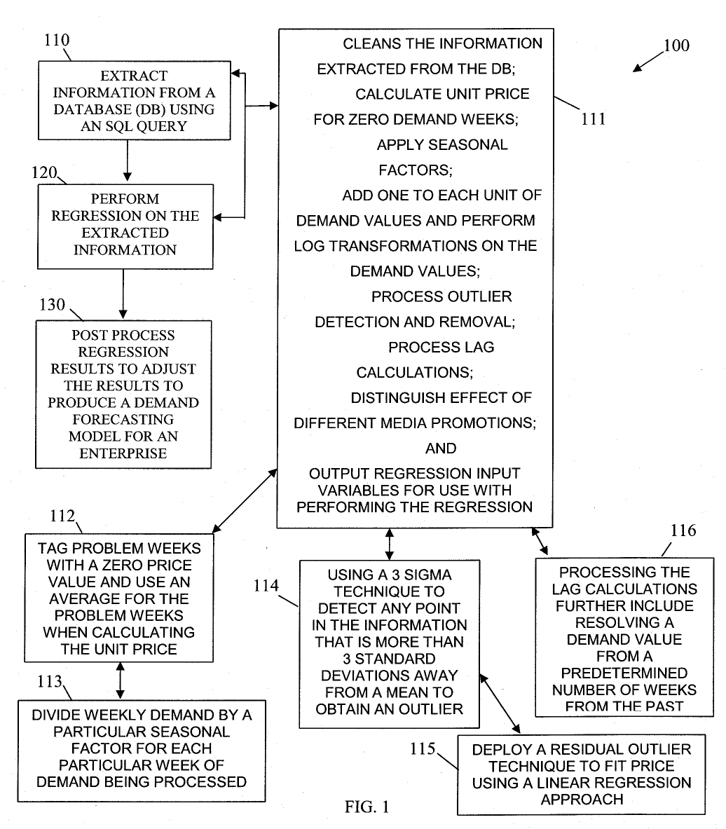

The detail of the techniques referenced below with reference to the FIGS. 1-3 exist in the above-disclosed discussion along with examples, diagrams, and sample pseudo code for achieving each technique described below.

FIG. 1 is a diagram of a method 100 for casual demand forecasting, according to an example embodiment. The method 100 (hereinafter “casual regression service”) is implemented in a machine-accessible or computer-readable medium as instructions that when executed by a plurality of machines (e.g., computers, processing devices, etc.) performs the processing depicted in FIG. 1. Moreover, the casual regression service is accessible over a network. The network may be wired, wireless, or a combination of wired and wireless.

A “database” as used herein is a relational database, or a collection of databases organized as a data warehouse. According to an embodiment, the database is a Teradata® product or service distributed by Teradata of Dayton, Ohio.

The database includes a variety of enterprise information organized in tables. One type of information is referred to as an “entity.” An entity is something that can be uniquely identified (e.g., a customer account, a customer name, a store, a product, a household name, a logical grouping of certain types of customers, etc.). Each entity includes related information such as sales, expenses, inventories, transaction history, etc. In fact, the relationships and types of information can vary and can be configured in any manner desired by an enterprise.

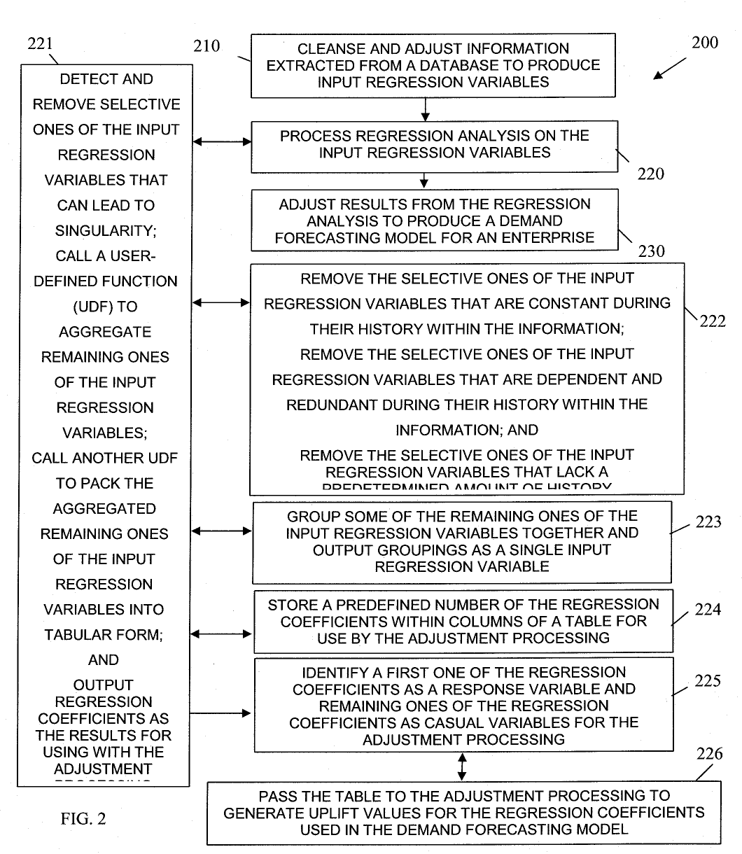

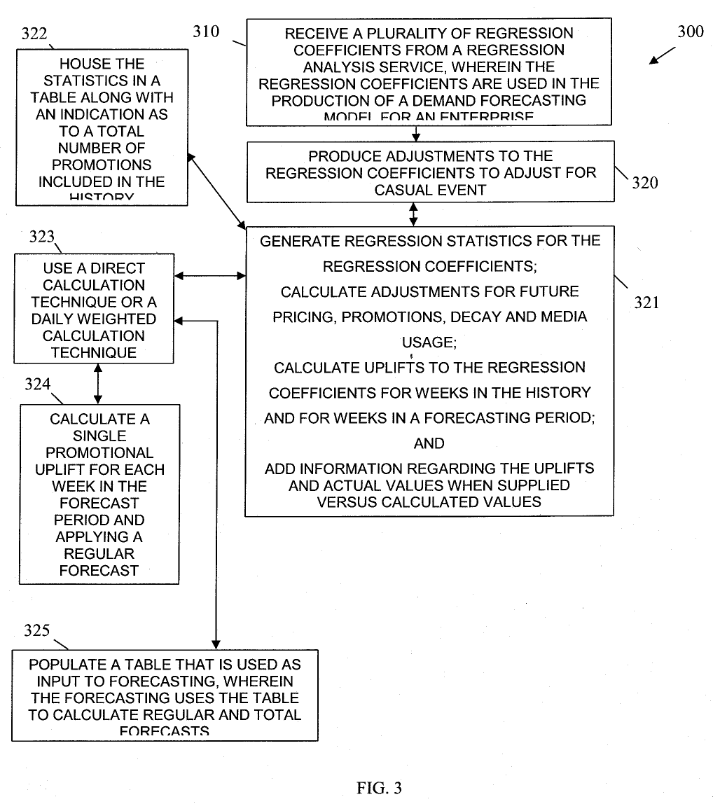

Initially, it is noted that the focus of the FIG. 1 is on the first processing step or the preprocessing step of the casual regression. FIG. 2 focuses on the regression and FIG. 3 focuses on the post processing.

At 110, the casual regression service extracts information extracts information that is to be processed into regression input variables from a relational database using SQL. Any SQL query can be used that is designed to retrieve all the data fields and information needed to adequately produce a demand forecasting model using casual regression. This data is then further preprocessed in the manners discussed below.

Specifically and in according to an embodiment, at 111, the casual regression service cleans the information retrieved from the database. In an embodiment, at 112, the casual regression service cleanses the information by flagging problem weeks of information that are associated with zero price value. In such a case, an average is used to calculate the unit price for these types of problems weeks.

Continuing with the processing at 111, the casual regression service also calculates unit prices for zero demand weeks. Again, at 111, the casual regression service applies seasonal factors. For example, at 113, the casual regression service divides weekly demand by a particular seasonal factor for each particular week of demand being calculated.

Once again, continuing with the processing at 111, the casual regression service adds one to each unit of demand values and performs log transformations on those demand values. Examples of this were described in detail above along with algorithms and formulas for achieving the same.

Again, at 111, the casual regression service performs outlier detection and removal. Specifically, at 114, the casual regression service can use a 3 Sigma technique to detect any point in the information being processed that is more than 3 standard deviations away from a mean to obtain an outlier. In one case, at 115, the casual regression service uses a residual outlier technique to fit price using a linear regression approach. This was also discussed in detail above along with formulas and algorithms for achieving the same.

Furthermore, at 111, the casual regression service processes a number of lag calculations. In one situation, at 116, the casual regression service resolves a particular demand value from a predetermined number of weeks from the past.

Still, at 111, the casual regression service distinguishes and quantifies the effects on demand from using different media promotions (e.g., television, phone campaign, snail mail, email, web-based, etc.).

Finally, at 111, the casual regression service outputs pre-processed regression input variables for use with the regression.

Accordingly, at 120, the casual regression service performs regression on the extracted information using the pre-processed regression input variables messaged and altered by the processing described above with reference to 110-116.

At 130, the casual regression service post processes the regression results (coefficients) produced by the regression analysis, at 120, to adjust the results and to produce a casual demand forecasting module for an enterprise. This model can be produced for a specific product or service of a particular enterprise. The exact processing details were described in significant detail above (before reference to the FIG. 1).

More details regarding regression and the post processing now follows with reference to the FIGS. 1 and 2.

FIG. 2 is a diagram of another method 200 for casual demand forecasting, according to an example embodiment. The method 200 (hereinafter “regression service”) is implemented in multiple machine-accessible and readable media as instructions that when executed by machines perform the processing reflected in FIG. 2. The regression service is accessible over a network. The network may be wired, wireless, or a combination of wired and wireless.

The regression service presents an enhanced view and different aspect of the casual regression service presented above and represented by the method 100 of the FIG. 1.

The regression service describes with more specificity the regression analysis. However, algorithms and examples were presented above in the descriptions that preceded the FIG. 1.

At 210, the regression service cleanses and adjusts information extracted from a database to produce input regression variables for a specific product or service of a specific enterprise. This was described in detail above with reference to the method 100 of the FIG. 1.

At 220, the regression service processes regression analysis on the input regression variables. This can be done in a variety of manners and detail, a variety of which was described at length above in the discussion that preceded the discussion of the method 100 of the FIG. 1.

For example, at 221, the regression service detects and removes selective ones of the regression input variables that can lead to a singularity situation. So, at 222, the regression service removes input variables that appear constant within their history, removes input variables that are dependent and redundant within their history, and/or removes input variables that lack a sufficient predefined amount of history to adequately produce accurate regression results.

Continuing at 221, the regression service then calls a user-defined function (UDF) to perform aggregation on remaining ones of the input variables that were not removed by the processing at 222. Here, at 223, the regression service can group some of the remaining input regression variables together and then produce a single input regression variable for the grouping.

Also, at 221, the regression service calls another UDF to pack the remaining ones of the input regression variables into a tabular format for use during post processing or adjustment on the results of the regression (regression coefficients). So, at 224, the regression service can store a predetermined number of the regression coefficients (regression results) in columns of an output table for use by the adjustment processing at 230 (post processing). At 225, the regression service identifies a first one of the regression coefficients as a response variable and the remaining ones of the regression coefficients as casual variables for use by the adjustment processing at 230 (post processing). At 226, the regression service passes the table to the adjustment processing for purposes of generating uplift values for the regression coefficients that are then used in the generated casual demand forecasting model.

Finally, at 221, the regression service outputs the regression coefficients for use by the adjustment processing.

At 230, the regression service adjust results (regression coefficients) produced from the regression analysis (220-226) for purposes of producing a casual demand forecasting model.

More particulars with respect to the post-processing or adjustment processing discussed at 230 are now discussed with reference to the FIG. 3.

FIG. 3 is still another method 300 for casual demand forecasting, according to an example embodiment. The method 200 (hereinafter “demand forecasting service”) is implemented in multiple machine-accessible and readable media as instructions that when executed by machines perform the processing reflected in FIG. 3. The demand forecasting service is accessible over a network. The network may be wired, wireless, or a combination of wired and wireless.

The demand forecasting service presents an enhanced view and different aspect of the casual regression service presented above and represented by the method 100 of the FIG. 1 and the regression service presented above and represented by the method 200 of the FIG. 2.

The demand forecasting service focuses on more details associated with the post processing of regression results. Again, algorithms, pseudo code, and examples of this processing were described in detail above in the discussion that preceded the FIG. 1 discussion.

At 310, the demand forecasting service receives a plurality of regression coefficients from a regression analysis service. The regression coefficients are used in the production of a casual demand forecasting module for a particular product or service of an enterprise. This was discussed above with reference to the method 200 of the FIG. 2.

At 320, the demand forecasting service produces adjustments (uplifts, etc.) to the regression coefficients for purposes of adjusting for casual events or circumstances. This can be achieved in a variety of manners.

For example, at 321, the demand forecasting service generates regression statistics for the regression coefficients. At 322, the demand forecasting service houses the statistics in a table along with an indication as to a total number of promotions associated with the history of the product or service for which the demand forecasting module is being produced.

Also, at 321, the demand forecasting service calculates adjustments for future pricing scenarios, decay, promotions, and/or different types of media usage for use with the promotions. At 323, the demand forecasting service can use a direct calculation technique or a daily weighted calculation technique. So, at 324, the demand forecasting service calculates a single promotional uplift for each week in the forecasting period and applies or uses a regular forecast calculation. This is done with the direct calculation approach. In a daily weighted calculation approach, at 325, the demand forecasting service populates a table that is used as input to forecasting. The forecasting uses the table to calculate regular and total forecasts. Specific detailed examples and implementations for the direct and daily weighted calculation approaches were presented in detail above in the discussion that preceded the discussion of the FIG. 1.

Continuing, at 321, the demand forecasting service then calculates uplifts for the regression coefficients for weeks in the history and for weeks in the forecasting period.

Finally, at 321, the demand forecasting service adds information regarding the uplift values and adds information for actual values supplied versus calculated values.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
extracting information from a database using an SQL query;
performing regression on the extracted information; and
post processing regression results to adjust the results to produce a demand forecasting model for an enterprise.

2. The method of claim 1, wherein extracting further includes:
cleansing the information extracted from the database;
calculating unit price for zero demand weeks;
applying seasonal factors;
adding one to each unit of demand values and performing log transformations on the demand values;
processing outlier detection and removal;
processing lag calculations;
distinguishing effect of different media promotions; and
outputting regression input variables for use with performing the regression.

3. The method of claim 2, wherein cleansing further includes tagging problem weeks with a zero price value and using an average for the problem weeks when calculating the unit price.

4. The method of claim 3, wherein applying further includes dividing weekly demand by a particular seasonal factor for each particular week of demand being processed.

5. The method of claim 2, wherein outlier detection and removal further includes using a 3 Sigma technique detect any point in the information that is more than 3 standard deviations away from a mean to obtain an outlier.

6. The method of claim 5, wherein using further includes deploying a residual outlier technique to fit price using a linear regression approach.

7. The method of claim 2, wherein processing the lag calculations further include resolving a demand value a predetermined number of weeks from the past.

8. A machine-implemented method, comprising:
cleansing and adjusting information extracted from a database to produce input regression variables;
processing regression analysis on the input regression variables; and
adjusting results from the regression analysis to produce a demand forecasting model for an enterprise.

9. The method of claim 8, wherein processing further includes:
detecting and removing selective ones of the input regression variables that can lead to singularity;
calling a user-defined function (UDF) to aggregate remaining ones of the input regression variables;
calling another UDF to pack the aggregated remaining ones of the input regression variables into tabular form; and
outputting regression coefficients as the results for using with the adjustment processing.

10. The method of claim 9, wherein detecting and removing further includes:
removing the selective ones of the input regression variables that are constant during their history within the information;
removing the selective ones of the input regression variables that are dependent and redundant during their history within the information; and
removing the selective ones of the input regression variables that lack a predetermined amount of history.

11. The method of claim 9, wherein calling the UDF to aggregate further includes grouping some of the remaining ones of the input regression variables together and outputting groupings as a single input regression variable.

12. The method of claim 9, wherein calling the other UDF further includes storing a predefined number of the regression coefficients within columns of a table for use by the adjustment processing.

13. The method of claim 12, wherein storing further includes identifying a first one of the regression coefficients as a response variable and remaining ones of the regression coefficients as casual variables for the adjustment processing.

14. The method of claim 13 further comprising, passing the table to the adjustment processing to generate uplift values for the regression coefficients used in the demand forecasting model.

15. A machine-implemented method, comprising:
receiving a plurality of regression coefficients from a regression analysis service, wherein the regression coefficients are used in the production of a demand forecasting model for an enterprise; and
producing adjustments to the regression coefficients to adjust for casual events.

16. The system of claim 15, wherein producing further includes:
generating regression statistics for the regression coefficients;
calculating adjustments for future pricing, promotions, decay and media usage;
calculating uplifts to the regression coefficients for weeks in the history and for weeks in a forecasting period; and
adding information regarding the uplifts and actual values when supplied versus calculated values.

17. The system of claim 16, wherein generating further includes housing the statistics in a table along with an indication as to a total number of promotions included in the history.

18. The system of claim 16, wherein calculating adjustments further includes using a direct calculation technique or a daily weighted calculation technique.

19. The system of claim 18, wherein using the direct calculation technique further includes calculating a single promotional uplift for each week in the forecast period and applying a regular forecast.

20. The system of claim 18, wherein using the daily weighted calculation technique further includes populating a table that is used as input to forecasting, wherein the forecasting uses the table to calculate regular and total forecasts.
